(19) United States
(12) Patent Application Publication
(10) Pub. No.: US 2016/0224060 A1
(43) Pub. Date: Aug. 4, 2016

(54) WEARABLE ELECTRONIC DEVICE

(71) Applicant: Samsung Electronics Co., Ltd., Gyeonggi-do (KR)

(72) Inventors: Joonki YUN, Seoul (KR); Jaehun KO, Seoul (KR); Hayoul JUNG, Gyeonggi-do (KR)

(73) Assignee: Samsung Electronics Co., Ltd.

(21) Appl. No.: 15/012,406

(22) Filed: Feb. 1, 2016

(30) Foreign Application Priority Data
Jan. 30, 2015 (KR) 10-2015-0015501

(51) Int. Cl. G06F 1/16

(52) U.S. Cl. CPC G06F 1/163

(57) ABSTRACT

A wearable device is provided, which includes a first function part that is integrally coupled to or separated from the first function part and strings that are connected to the first and second function parts, respectively, so as to allow the first and second function parts to be worn on a neck. The strings are provided with earphone parts and a retainer. The strings are pulled by a length that is sufficient to wear the earphone parts on ears when the retainer is held by a hand, and then the earphone parts are worn on the ears.

### PRIORITY

This application claims priority under 35 U.S.C. §119(a) to Korean Patent Application Serial No. 10-2015-0015501, which was filed in the Korean Intellectual Property Office on Jan. 30, 2015, the entire content of which is incorporated herein by reference.

### BACKGROUND

1. Field of the Disclosure

The present disclosure generally relates to a wearable electronic device that is worn on a neck.

2. Description of the Related Art

An electronic device may be carried within a user's pocket, a bag and the like, by holding and carrying by hand, or by wearing the device on a predetermined position of the user's body. A wearable device refers to an electronic device that may be worn on various portions of the user's body.

There are various methods of wearing a wearable device on a user's body, which may be simply classified as follows based on a wearing method or a wearing position:

1. Wearing the wearable device on a user's body, such as a wrist, as a watch or band type.

2. Wearing the wearable device around a user's body as a necklace type.

3. Wearing the wearable device on a face in a similar manner to wearing eyeglasses.

4. Wearing the wearable device by putting it on a portion of a user's body, clothing or using a clip.

5. Directly or indirectly attaching the wearable device to a user's body, clothing or belonging.

A wearable device can be conveniently worn on various positions of the user's body, should be convenient to use while it is worn, and should be conveniently carried or stored when it is not worn.

### SUMMARY

An aspect of the present disclosure provides a wearable device that is conveniently carried, conveniently worn, and easily managed when it is not worn.

Another aspect of the present disclosure provides a wearable device that is configured where respective parts may be separated from/coupled to each other such that various functions are enabled.

Another aspect of the present disclosure provides a wearable device that is worn by separating a main part from a battery part, wearing the main part and the battery part, and then pulling and wearing ear parts.

Another aspect of the present disclosure provides a wearable device in which a main part and an assembly part may be separated from/coupled to each other.

Another aspect of the present disclosure provides a wearable device in which an auxiliary battery is mounted on each part so that power shut off can be prevented when separating the parts.

According to an aspect of the present disclosure, a wearable device is provided that includes a first function part, a second function part that is integrally coupled to or separated from the first function part, and strings that are connected to the first and second function parts, respectively, to allow the first and second function parts to be worn on a neck.

According to an aspect of the present disclosure, a wearable device is provided that includes a first function part, a second function part that is integrally coupled to or separated from the first function part, and strings that are connected to the first and second function parts, respectively, to allow the first and second function parts to be worn on a neck. The strings may be provided with earphone parts and a retainer. The strings may be pulled by a length that is sufficient to wear the earphone parts on ears in which the retainer is held by a hand, and the earphone parts may be worn on the ears.

According to an aspect of the present disclosure, a wearable device is provided that may include a wearable device that includes at least one function part that is worn on a neck using a string. The string may be provided with an earphone part and a retainer, and the earphone part may be worn on an ear by pulling the string while holding the retainer when the wearable device is worn on the neck.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a configuration of a wearable device according to various embodiments of the present disclosure;

FIG. 2 is a perspective view illustrating function parts that form a main body of the wearable device according to various embodiments of the present disclosure;

FIG. 3 is a side view of FIG. 2;

FIG. 4 is a cross-sectional view illustrating a coupled state of the main part and the battery part of the wearable device according to various embodiments of the present disclosure;

FIG. 5 is a cross-sectional view illustrating a connected state of the main part and the battery part of the wearable device according to various embodiments of the present disclosure;

FIG. 6 is a view illustrating an outer surface of the main part according to various embodiments of the present disclosure;

FIG. 7 is a perspective view illustrating function parts that form a main body of a wearable device according to various embodiments of the present disclosure;

FIG. 8 is a side view of FIG. 7;

FIG. 9 is a cross-sectional view illustrating a coupled state of the main part, the additional function part, and the battery part of the wearable device according to various embodiments of the present disclosure;

FIG. 10 is a cross-sectional view illustrating a connected state of the main part, the additional function part, and the battery part of the wearable device according to various embodiments of the present disclosure;

FIG. 11A is a perspective view illustrating a retainer that is provided to a wearable device according to various embodiments of the present disclosure;

FIG. 11B is a cross-sectional view illustrating the retainer that is provided to a wearable device according to various embodiments of the present disclosure;

FIG. 12 is a view illustrating a practical wearable device according to various embodiments of the present disclosure;

FIG. 13A is a view illustrating a wearable device according to various embodiments of the present disclosure worn on a neck;

FIG. 13B is a view illustrating earphone parts of the wearable device according to various embodiments of the present disclosure pulled but not worn on ears; and

FIG. 13C is a view illustrating earphone parts of the wearable device according to various embodiments of the present disclosure pulled and worn on ears.

### DETAILED DESCRIPTION

Hereinafter, various embodiments of the present disclosure will be explained with reference to the accompanying drawings. Although specific embodiments of the present disclosure are illustrated in the drawings and relevant detailed descriptions are provided, various changes may be made and various embodiments may be provided. Accordingly, various embodiments of the present disclosure are not limited to the specific embodiments and should be construed as including all changes and/or equivalents or substitutes included in the ideas and technical scope of embodiments of the present disclosure. In describing the drawings, similar reference numerals are used for similar elements.

The terms “include” or “may include” used in the embodiments of the present disclosure indicate the presence of disclosed corresponding functions, operations, elements, and the like, and do not limit additional one or more functions, operations, elements, and the like. In addition, it should be understood that the terms “include” or “have” used in the embodiments of the present disclosure indicate the presence of features, numbers, steps, operations, elements, parts, or a combination thereof described in the specification, and do not preclude the presence or addition of one or more other features, numbers, steps, operations, elements, parts, or a combination thereof.

The term “or” used in the embodiments of the present disclosure include any and all combinations of words enumerated with it. For example, “A or B” means including A, including B, or including both A and B.

Although the terms such as “first” and “second” used in the various embodiments of the present disclosure may modify various elements of the various embodiments, these terms do not limit the corresponding elements. For example, these terms do not limit an order and/or importance of the corresponding elements. These terms may be used for the purpose of distinguishing one element from another element. For example, a first electronic device and a second electronic device all indicate electronic devices and may indicate different electronic devices. For example, a first element may be referred to as a second element without departing from the scope of the various embodiments of the present disclosure, and similarly, a second element may be referred to as a first element.

It will be understood that, when an element is mentioned as being “connected” or “coupled” to another element, the element may be directly connected or coupled to another element, and there may be an intervening element between the element and another element. On the contrary, it will be understood that, when an element is mentioned as being “directly connected” or “directly coupled” to another element, there is no intervening element between the element and another element.

The terms used in the various embodiments of the present disclosure are for the purpose of describing specific embodiments only and do not limit various embodiments of the present disclosure. As used herein, singular forms are intended to include plural forms as well, unless the context clearly indicates otherwise. All of the terms used herein, including technical or scientific terms have the same meanings as those generally understood by a person of ordinary skill in the related art unless they are defined otherwise. The terms defined in a generally used dictionary should be interpreted as having the same meanings as the contextual meanings of the relevant technology and should not be interpreted as having ideal or exaggerated meanings unless they are clearly defined in the various embodiments.

An electronic device according to various embodiments of the present disclosure may be a device that is equipped with a communication function. For example, the electronic device may include at least one of a smartphone, a tablet personal computer (PC), a mobile phone, a video phone, an electronic book reader, a desktop PC, a laptop PC, a netbook computer, a Personal Digital Assistant (PDA), a Portable Multimedia Player (PMP), an MP3 player, a mobile medical machine, a camera, or a wearable device (for example, a head-mounted-device (HMD) such as electronic glasses, electronic clothing, an electronic bracelet, an electronic necklace, an electronic appcessory, electronic tattoos, or a smart watch).

The electronic device according to various embodiments of the present disclosure may be one or a combination of one or more of the above-mentioned devices. In addition, the electronic device according to various embodiments of the present disclosure may be a flexible device. In addition, it is obvious to a person of ordinary skill in the related art that the electronic device according to various embodiments of the present disclosure is not limited to the above-mentioned devices.

Hereinafter, an electronic device according to various embodiments of the present disclosure will be explained with reference to the accompanying drawings. The term “user” used in the various embodiments of the present disclosure may refer to a person who uses the electronic device or a device that uses the electronic device (for example, an artificial intelligence electronic device).

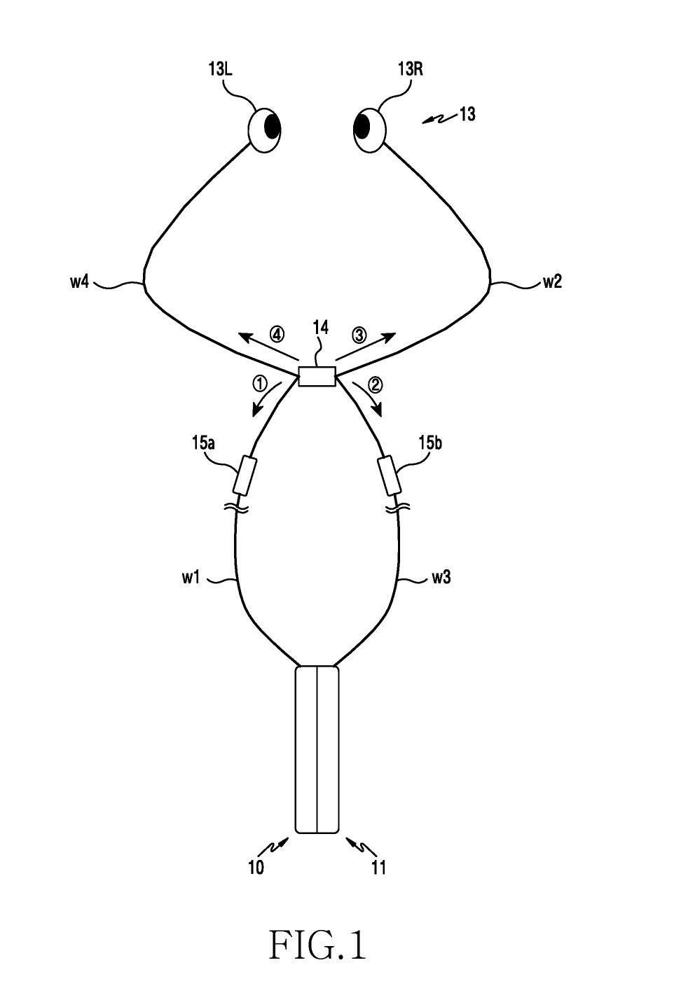

FIG. 1 is a configuration of a wearable device according to various embodiments of the present disclosure.

The wearable device may be a neck mount type wearable device in view of its position as worn on a user's body. In particular, the wearable device may be a type to be worn by putting it around the neck using strings w1 to w4. In addition, the wearable device may provide a new wearing method in which a first function part 10 and a second function part 11, which form the main body of the wearable device, are separated from each other to place the wearable device on the neck, and then third function parts 13R and 13L are pulled and worn.

For the convenience of description of the present disclosure, the first function part 10 will be referred to as a main part, the second function part 11 will be referred to as a battery part, and the third function parts 13L and 13R will be referred to as earphone parts. The terms refer to function parts, which form the main body, for the convenience of description, and the definitions of the technical terms that refer to the first, second and third function parts may be changed depending on various types of wearable devices. For example, when the main part is provided with a display, the main part may be referred to as a display part, and when a camera module is mounted on the battery part, the battery part may be referred to as a camera part.

According to various embodiments of the present disclosure, the wearable device may include a main part 10 and a battery part 11, which may be physically coupled to and separated from each other, strings w1, w2 and w3, w4, each of which is connected to the main part 10 and battery part 11 to allow the main part 10 and battery part 11 to be worn on a neck and earphone parts 13R and 13L, which are connected to the strings w1 to w4.

The main part 10 and the battery part 11 may include coupling structures that can be physically coupled to each other and can maintain the coupled state. The coupling structures will be described in detail below. The main part 10 and the battery part 11 are bodies that are classified based on the functions thereof. The main part 10 and the battery part 11 may be referred to as a first function part and a second function part, respectively, or may be referred to as a first module (main module) and a second module (battery module).

The main part 10 may be connected to one earphone 13R by a first string w1, w2, and the battery part 11 may be connected to another earphone 13L by a second string w3, w4. In other words, one end of the first string w1, w2 may be fixed to the main part 10, and the other end may be fixed to one earphone 13R. In addition, one end of the second string w3, w4 may be fixed to the battery part 11, and the other end may be fixed to the other earphone 13L. Each of the first and second strings w1, w2 and w3, w4 may be maintained in a pulled state by a retainer 14. Detailed descriptions on the retainer 14 that maintains the pulled states of the first and second strings w1, w2 and w3, w4 will be made below. The first string w1, w2 may function to physically and electrically connect the main part 10 and one earphone 13R to each other, and the second strings w3, w4 may function to physically and electrically connect the battery part 11 and the other earphone 13L to each other. In addition, the entire length of each of the first and second strings w1, w2 and w3, w4 is not changed, and the first and second strings w1, w2 and w3, w4 may have equal or similar lengths.

The main function of the retainer 14 is to maintain the pulled state of the first and second strings w1, w2 and w3, w4. However, an additional function of the retainer 14 is to maintain the length of the first and second strings w1, w2 and w3, w4 to be the same as or similar to each other.

The first and second strings w1, w2 and w3, w4 include first and second string portions w1 and w2 and third and fourth string portions w3 and w4, respectively. By using the retainer 14, the first and second strings portions w1 and w2 and the third and fourth string portions w3 and w4 may be movable.

The first string portion w1 may be a string portion that exists between the main part 10 and the retainer 14, and the second string portion w2 may be a string portion that exists between the retainer 14 and one earphone 13R. The third string portion w3 may be a string portion that exists between the battery part 11 and the retainer 14, and the fourth string portion w4 may be a string portion that exists between the retainer 14 and another earphone 13L. The length of each of the first and second string portions w1 and w2 may be changed depending on whether each of the first and second string portions w1 and w2 is pulled while fixing the retainer 14. The length of each of the third and fourth string portions w3 and w4 may also be changed depending on whether each of the third and fourth string portions w3 and w4 is pulled while fixing the relative position of the retainer 14. Arrows 1 to 4, which are indicated in the drawing, represent directions in which the strings may be pulled.

The first string portion w1 may be provided with a sound device such as a speaker 15a. When the speaker 15a is not provided on the first string portion w1, the speaker 15a may be mounted on the main part 10 or the battery part 11. The third string portion w2 may be provided with a sound device such as a microphone 15b. When the speaker 15b is not provided on the third string portion w3, the microphone 15b may be mounted on the main part 10 or the battery part 11. In addition, the wearable device may be provided with a volume adjustment key. In particular, the volume adjustment key may be provided on any of the first to fourth string portions w1 to w4. When the volume adjustment key is not provided on the first to fourth string portions w1 to w4, the volume adjustment key may be mounted on the main part 10 or the battery part 11.

A wearing method will be described below with reference to FIG. 1. First, the user separates the main part 10 and the battery part 11, and then puts the main part 10 and the battery part 11 on the neck. Subsequently, the user couples the main part 10 and the battery part 11 to each other. Subsequently, the user may hold the retainer 14 and pull the string portions w3 and w4 so as to lengthen the string portions w3 and w4, and may then wear the earphones 13R and 13L on the ears, respectively. One end of each of the string portions w1 and w3 may be provided with a plug terminal for connecting to or separating from the first function part.

Hereinafter, descriptions will be made on configurations of respective parts that form a main body according to various embodiments of the present disclosure.

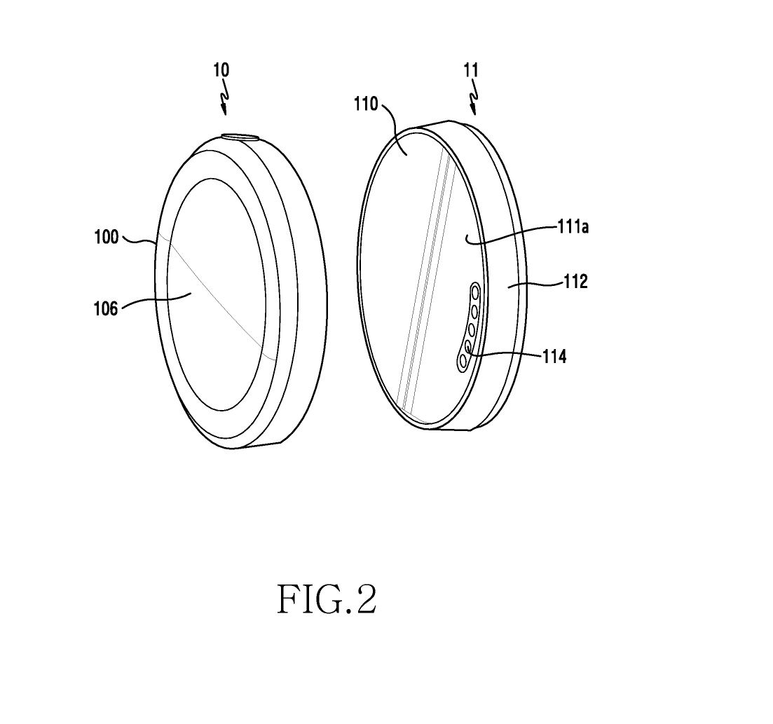

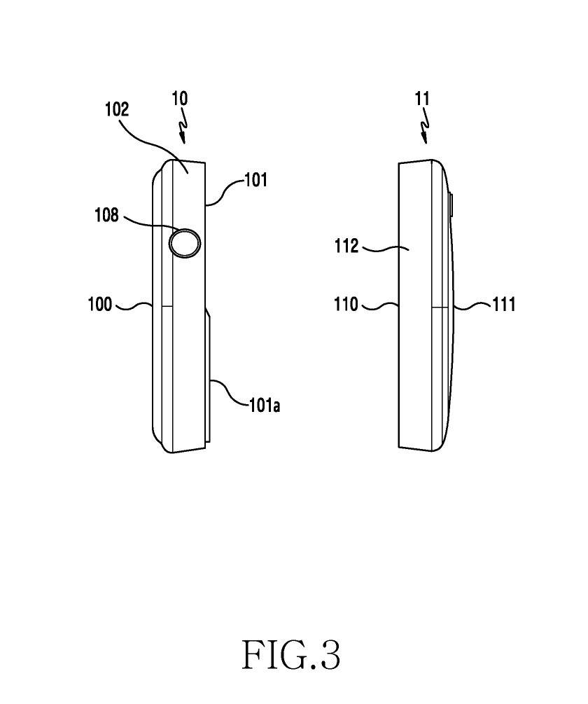

FIG. 2 is a perspective view illustrating function parts that form a main body of the wearable device according to various embodiments of the present disclosure. FIG. 3 is a side view of FIG. 2.

Referring to FIGS. 2 to 3, according to various embodiments of the present disclosure, the wearable device includes a main part 10 and a battery part 11 that is coupled to or separated from the main part 10. The main part 10 and the battery part 11 are coupled to each other to face each other, or may be forcibly separated from each other. Since the main part 10 and the battery part 11 are configured to be separated from each other, the wearable device may be easily put around the neck after two parts 10 and 11 are separated from each other. After the wearable device is put around the neck and then two parts 10 and 11 are coupled to each other, the earphones may be easily worn on the ears.

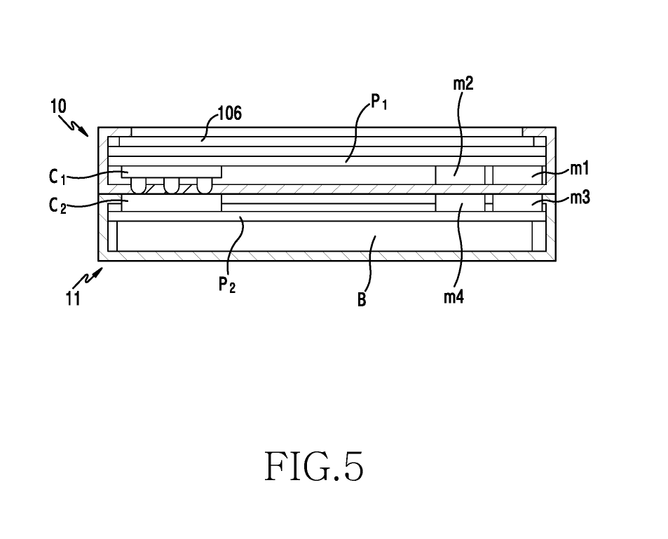

The main part 10 is formed in a coin shape to have an outer surface 100, an inner surface 101, and an outer peripheral surface 102. The battery part 11 is formed in a coin shape to have an outer surface 111, an inner surface 110, and an outer peripheral surface 112. The main part 10 is equipped with a display 106 or a touch screen panel (TSP) on the outer surface 100, and is provided with an insertion hole 108 on the outer peripheral surface 102, into which an earphone may be plugged. The inner surface 101 of the main part is arranged such that a connecting terminal (see FIG. 5) is exposed. The battery part 11 includes one or more connecting terminals 114 that are arranged on the inner surface 110.

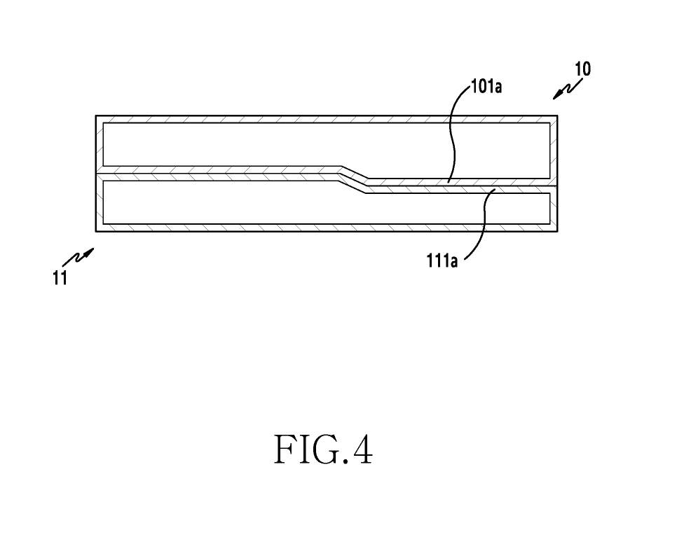

FIG. 4 is a cross-sectional view illustrating a coupled state of the main part and the battery part of the wearable device according to various embodiments of the present disclosure.

Referring to FIG. 4, the wearable device includes a coupling structure that is provided between the main part 10 and the battery part 11. This structure ensures that the main part 10 and the battery part 11 are coupled to face each other, a coupling position is determined, and then the coupled state is not moved. At least a portion of the inner surface of the main part 10 is formed as a protrusion region 101a, and at least a portion of the inner surface of the battery part 11 is formed as a recess region 111a. Each of the protrusion region 101a and the recess region 111a may be configured to occupy about one half of the inner surface area of each of the parts.

FIG. 5 is a cross-sectional view illustrating a connected state of the main part and the battery part of the wearable device according to various embodiments of the present disclosure.

Referring to FIG. 5, the wearable device includes a connecting structure that is provided between the main part 10 and the battery part 11. The connection between the main part 10 and the battery part 11 may be implemented in a wired or wireless manner. The main part 10 is provided with a substrate p1, and the substrate p1 is provided with a display 106 or a TSP and a first connecting connector c1. The main part 11 is provided with a substrate p2, and the substrate p2 is provided with one or more battery cells B and a second connecting connector c2.

Connecting structures between the main part 10 and the battery part 11 may include the connecting connectors c1 and c2, respectively. The main part 10 may include the first connecting connector c1, and the battery part 11 may include the second connector c2 that may be connected to the first connecting connector c1 and may maintain the connected state. The structure of first connecting connector c1 may be, for example, a pogo pin. A pogo pin usually takes the form of a slender cylinder containing spring-loaded pins The first connecting connector c1 may include a plurality of connecting terminals. Each of the connecting terminals is supported by an elastic body to retract into or protrude from the main body of the first connecting connector. The second connecting connector c2 may be arranged such that a connecting surface is exposed to the inner surface 110 of the battery part.

The main part 10 may include one or more first magnetic bodies m1 and m2, and the battery part 11 may include one or more second magnetic bodies m3 and m4. The first magnetic bodies m1 and m2 and the second magnetic bodies m3 and m4 may be configured to have different polarities. A coupling force may be provided between the main part 10 and the battery part 11 and the coupled state thereof may be maintained by a pulling force (attraction) that is generated between the first magnetic bodies m1 and m2 and the second magnetic bodies m3 and m4, which may be forcibly separated from each other.

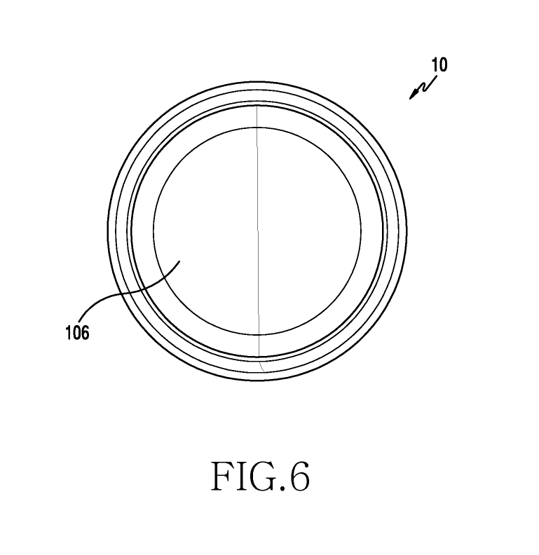

FIG. 6 is a view illustrating an outer surface of the main part according to various embodiments of the present disclosure.

Referring to FIG. 6, the main part 10 may include a display 106 that is arranged on the outer surface 100 thereof. The display 106 may include a touch screen panel (TSP). When the TSP is mounted on the outer surface 100, it is possible to implement a wearable device that has various user interface functions. When the display 106 includes the TSP, shortcut icons for executing frequently used applications, a main menu switching key, time, weather, and the like may be displayed on the screen of the main part 10. The main menu switching key may cause the main screen to be displayed on the display 106. In addition, in the upper end of the display 106, status bars may be formed to indicate status of the device, such as a battery charge status, a received signal strength, and the current time. The main part 10 may be formed with a home button, a menu button, and a back button.

In addition, the home button causes a main home screen to be displayed on the display 106. For example, when the home button is touched in the state where a home screen, which is different from the main home screen, or the menu screen is displayed on the display 106, the main home screen may be displayed on the display 106. In addition, when the home button is touched while the applications are executed and displayed the display 106, the main home screen may be displayed on the display 106. In addition, the home button may be used in order to cause the display 106 to display the most recently used application or a task manager.

The menu button provides a connection menu that may be used on the TSP. The connection menu may include a widget addition menu, a background screen change menu, a retrieve menu, an edition menu, an environment setting menu, and the like. The back button may cause the screen, which was executed just prior to the currently executed screen, to be displayed, or may cause the most recently used application to be terminated.

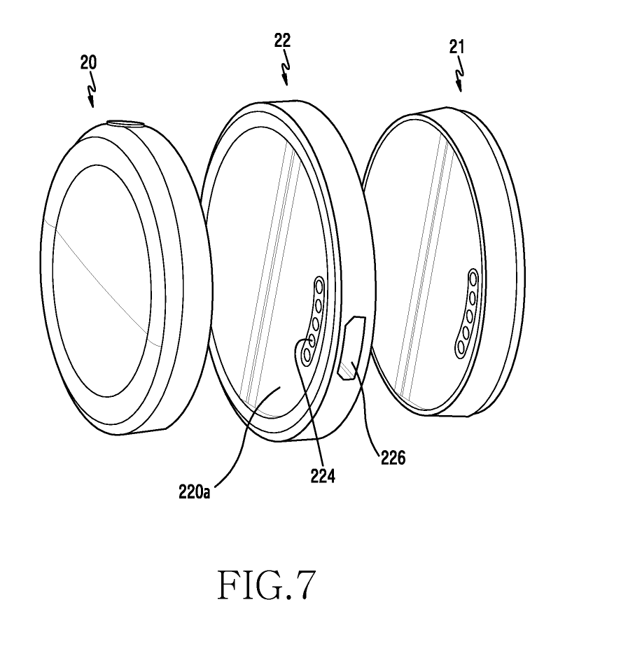

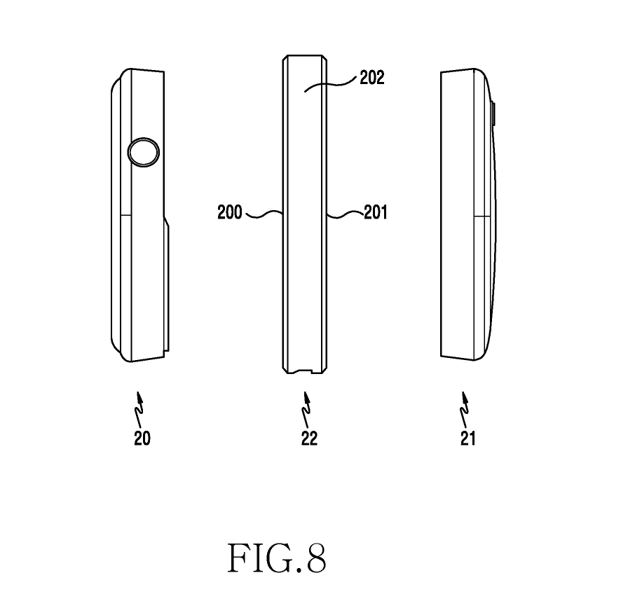

FIG. 7 is a perspective view illustrating function parts that form a main body of a wearable device according to various embodiments of the present disclosure. FIG. 8 is a side view of FIG. 7.

Referring to FIGS. 7 and 8, the main body of the wearable device includes a main part 20, a battery part 21, and at least one additional function part 22. The additional function part 22 may be arranged between the main part 20 and the battery part 21. However, the additional function part 22 may be arranged on the outer surface of the main part 20 or on the outer surface of the battery part 21. The arranged positions and the arranged number of additional function parts are not limited. The three above-mentioned parts may include a coupling structure that may physically couple and electrically connect the parts to each other.

Since the configurations of the main part 20 and the battery part 21 are the same as those of the main part 10 and the battery part 11 as illustrated in FIGS. 2 to 5, detailed descriptions thereof will be omitted. The additional function part 22 may be configured to have shapes that are equal or similar to those of the main part 20 and the battery part 21, respectively. The additional function part 22 may have an outer surface 200, an inner surface 201, and an outer peripheral surface 202. The additional function part may include connecting terminals 224 that are arranged on the outer surface thereof, and a USB connector 226 that is arranged on the outer peripheral surface thereof. The additional function part 22 may include a battery cell for charging, and may also include a camera module. The additional function part 22 may be coupled to the main part to be used as an auxiliary battery.

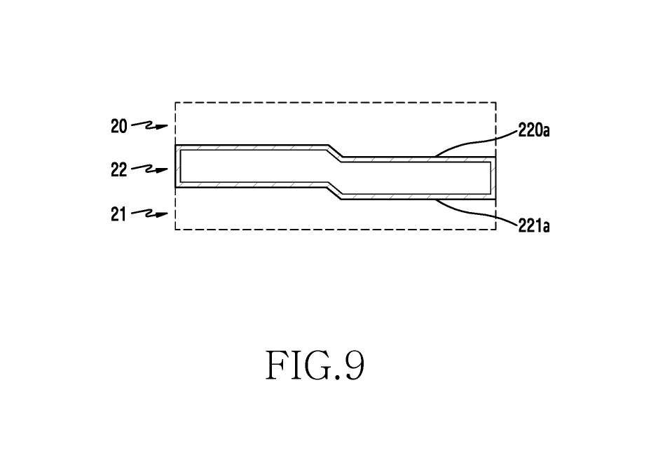

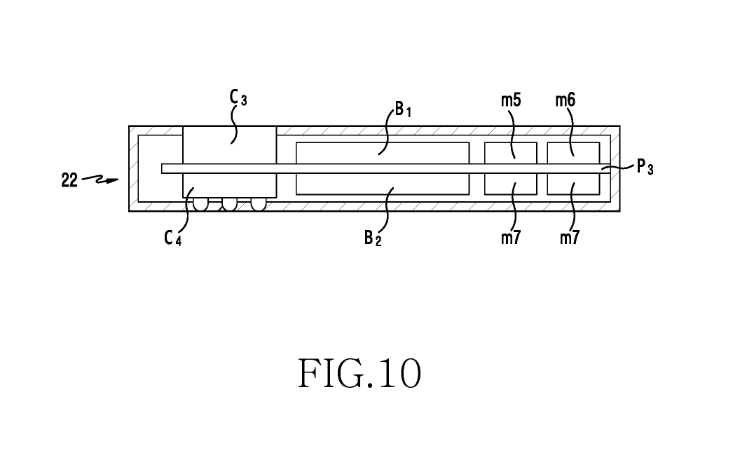

FIG. 9 is a cross-sectional view illustrating a coupled state of the main part 20, the additional function part 22, and the battery part 21 of the wearable device according to various embodiments of the present disclosure. FIG. 10 is a cross-sectional view illustrating a connected state of the main part 20, the additional function part 22, and the battery part 21 of the wearable device according to various embodiments of the present disclosure.

Referring to FIGS. 9 and 10, the outer surface 220 of the additional function part 22 refers to a surface that faces and is coupled to the inner surface of the main part 20, and is provided with a recess region (groove region) 220a. The recess region 220a may be a portion that is coupled to the protrusion region on the inner surface of the main part 20. The recess region 220a may include a third connecting connector c3. In addition, the inner surface 221 of the additional function part may include a protrusion region 221a. The protrusion region 221a may be a portion that is coupled to the recess region of the battery part 21. The additional function part 22 may be provided with magnetic bodies m5, m6, m7, and m8, with reference to the substrate p3. First magnetic bodies m5 and m6 may be arranged on one surface of the substrate p3, and second magnetic bodies m7 and m8, of which the polarity is different from that of the first magnetic bodies m5 and m6, may be provided on the other surface of the substrate p3. The first magnetic bodies m5 and m6 may provide a coupling force with the main part 20, and the second bodies m7 and m8 may provide a coupling force with the battery part 21. The additional function part 22 may be equipped with one or more battery cells B1 and B2.

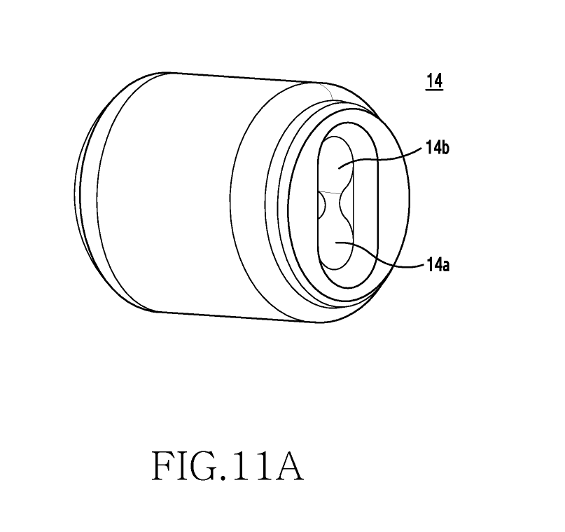

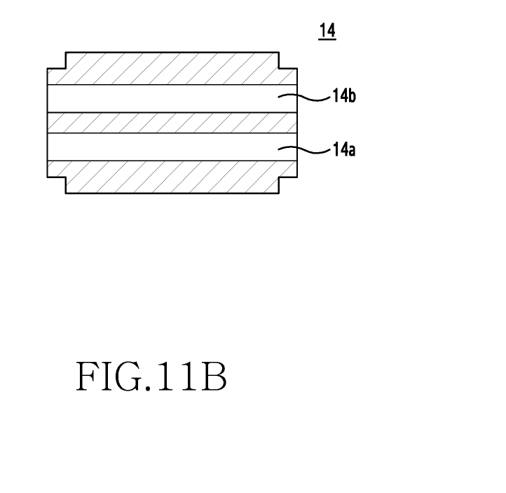

FIG. 11A is a perspective view illustrating a retainer provided to a wearable device according to various embodiments of the present disclosure, and FIG. 11B is a cross-sectional view illustrating the retainer provided in a wearable device according to various embodiments of the present disclosure.

Referring to FIGS. 11A and 11B together with FIG. 1, the wearable device includes a retainer 14 that maintains the pulled state of the strings. The retainer 14 is made of an elastic material that has a high friction coefficient, such as silicon or rubber, and is provided on the first string w1, w2 and the second string w2, w3 to maintain the pulled state of the first and second strings. The retainer 14 may include first and second openings 14a and 14b, through which the first and second strings extend. The string maintaining force of the retainer 14 may be generated by the friction between the outer sheath of the strings and the inner surfaces of the first and second openings of the retainer. In particular, the first and second strings may be conveniently used when the pulled lengths are equal to each other when the first and second strings are pulled. A separate structure may be added to the retainer 14 such that the retainer 14 is substantially equally moved in the longitudinal direction when the first and second strings are pulled.

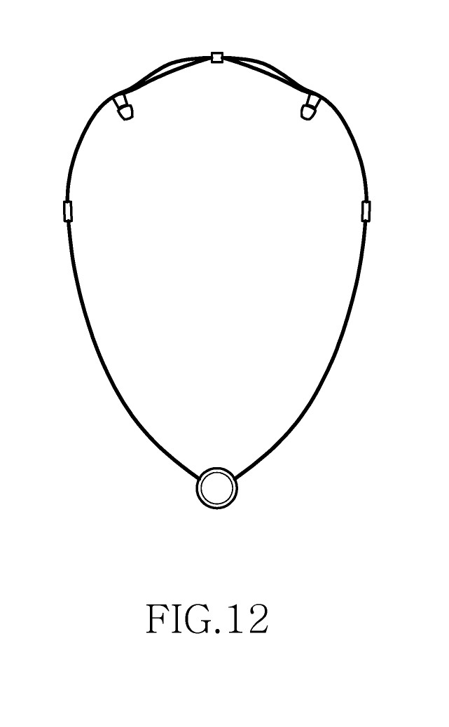

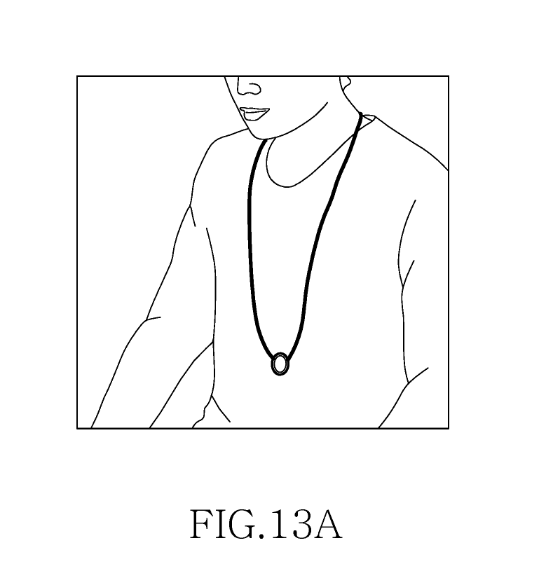

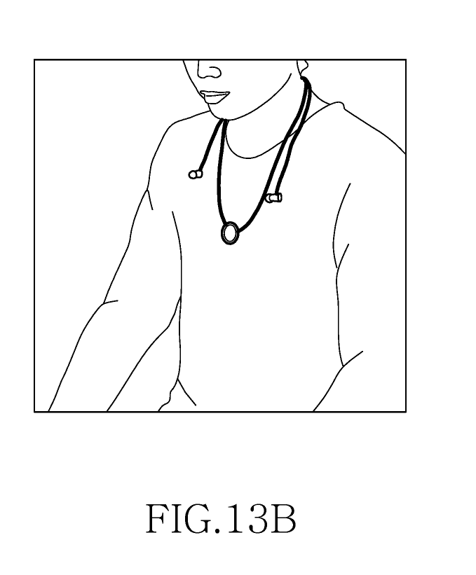

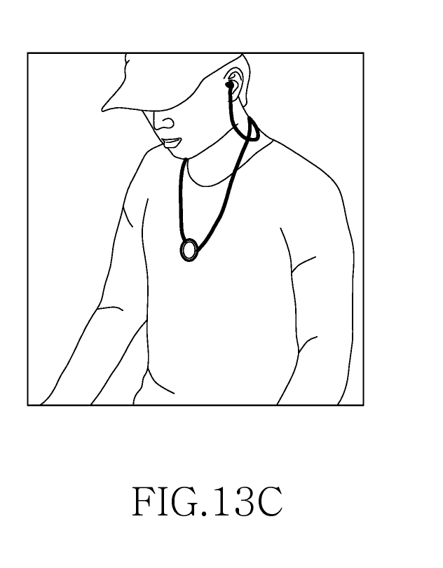

FIG. 12 is a view illustrating a practical wearable device according to various embodiments of the present disclosure. FIG. 13A is a view illustrating a state in which a wearable device according to various embodiments of the present disclosure is worn on a neck. FIG. 13B is a view illustrating a state in which earphone parts of a wearable device according to various embodiments of the present disclosure are pulled but not worn on ears. FIG. 13C is a view illustrating a state in which earphone parts of a wearable device according to various embodiments of the present disclosure are pulled and worn on ears.

Referring to FIGS. 12-13C, the wearable device may be worn in a manner in which the first and second function parts are separated from each other, the strings w1 and w3 are put around a neck, and the first and second function parts are coupled to each other. FIG. 13A shows such a state.

Subsequently, when it is desired to put the earphone parts 13l and 13r on the ears, the earphone parts 13l and 13r may be pulled by a predetermined length with reference to the retainer 14, and then the earphone parts 13l and 13r may be worn on the ears to be used. FIG. 13C shows such a state. When the earphone parts 13l and 13r are not worn on the ears, the earphone parts 13l and 13r may also be carried in the state where the earphone parts 13l and 13rare worn on the neck together with the first and second function parts. FIG. 13B shows such a state.

In addition, according to various embodiments of the present disclosure, the wearable device may be equipped with a battery in each of the battery part or the additional function part and may also be equipped with a battery in the main part in order to prevent the product from being damaged by cut-off of power even if the parts are separated from each other.

According to various embodiments of the present disclosure, the wearable device can be conveniently worn on the neck of the user's body, and is convenient when worn. Further, the wearable device may be conveniently carried or stored when the wearable device is not worn. In addition, the wearable device has a structure that is capable of changing functions or expanding functions.

According to various embodiments of the present disclosure, at least part of the apparatus of the present disclosure may be implemented by using instructions stored in a computer-readable storage medium in the form of a programming module. When the instructions are executed by one or more processors, the one or more processors may perform a function corresponding to the instructions. The computer-readable storage medium may be a memory, for example. At least part of the programming module may be implemented (for example, executed) by using the processor. At least part of the programming module may include a module, a program, a routine, sets of instructions, a process, and the like for performing one or more functions.

Examples of a computer-readable recording medium include magnetic media such as hard disks, floppy disks and magnetic tapes, optical media such as Compact Disc Read Only Memories (CD-ROMs) and Digital Versatile Disc (DVDs), magneto-optical media such as floptical disks, and hardware devices such as Read Only Memories (ROMs), Random Access Memories (RAMs) and flash memories that are configured to store and execute program commands (for example, the programming module). Examples of the program commands include machine language codes created by a compiler and high-level language codes that can be executed by a computer by using an interpreter. The above-described hardware devices may be configured to operate as one or more software modules for performing operations of various embodiments of the present disclosure, and vice versa.

A module or programming module according to various embodiments of the present disclosure may include one or more of the above-described elements, may omit some elements, or may further include additional elements. The operations performed by the module, the programming module, or the other elements according to various embodiments of the present disclosure may be performed serially, in parallel, repeatedly, or heuristically. In addition, some operations may be performed in a different order or may omitted, and additional operations may be added.

While the disclosure has been shown and described with reference to certain embodiments thereof, it will be understood by those skilled in the art that various changes in form and details may be made therein without departing from the spirit and scope of the disclosure as defined by the appended claims and their equivalents. Therefore, the scope of the disclosure is defined not by the detailed description of the disclosure but by the appended claims and their equivalents and all differences within the scope will be construed as being included in the present disclosure.

What is claimed is:

1. A wearable device comprising:
a first function part;
a second function part that is integrally coupled to or separable from the first function part; and
strings that are connected to the first and second function parts, respectively, so as to allow the first and second function parts to be worn on a user's neck.

2. The wearable device of claim 1, wherein, when the wearable device is worn on the user's neck, the first and second function parts are separated from each other, the strings are put around the user's neck, and then the first and second function parts are coupled to each other.

3. The wearable device of claim 1, wherein each of the strings is provided with a plug terminal at an end thereof to be connected to or separated from the first function part.

4. The wearable device of claim 1, wherein each of a coupling structure and a connecting structure is mounted between the first and second function parts.

5. The wearable device of claim 1, wherein at least one additional function part is coupled between the first and second function parts.

6. The wearable device of claim 1, wherein the first function part includes a display, and the second function part includes a battery.

7. A wearable device comprising:
a first function part;
a second function part that is integrally coupled to or separable from the first function part; and
strings that are connected to the first and second function parts, respectively, so as to allow the first and second function parts to be worn on a user's neck,
wherein the strings are provided with earphone parts and a retainer, and
wherein the strings are pulled by a length that is sufficient to wear the earphone parts on the user's ears when the retainer is held by the user's hand when the earphone parts are worn on the ears.

8. The wearable device of claim 7, wherein, when the wearable device is worn on the neck, the first and second function parts are separated from each other, the strings are put around the user's neck, and the first and second function parts are coupled to each other.

9. The wearable device of claim 7, wherein the retainer is provided on the strings between the first and second function parts and the earphone parts, and maintains the pulled state of the strings by friction between the strings and the retainer.

10. The wearable device of claim 7, wherein the first and second function parts are configured to be coupled to or separated from each other by a first coupling structure.

11. The wearable device of claim 10, wherein the first coupling structure determines a coupling position between the first and second function parts and maintains a coupled state by concave-convex shapes.

12. The wearable device of claim 10, wherein the first coupling structure provides a coupling force by magnetic bodies that are provided on the first and second function parts, respectively.

13. The wearable device of claim 7, wherein the first and second function parts are electrically connected to each other in a wired or wireless manner.

14. The wearable device of claim 7, wherein at least one additional function part is further coupled between the first and second function parts in a state where the first and second function parts face each other.

15. The wearable device of claim 14, wherein the at least one additional function part is coupled to or separated from each of the first function part and the second function part for battery charging.

16. The wearable device of claim 14, wherein at least one of the first, second, and additional function parts includes a battery.

17. The wearable device of claim 7, wherein one or more openings are provided in the retainer to allow the strings to pass through, and the pulled state of the strings is maintained by friction between the retainer and sheaths of the strings.

18. A wearable device comprising:
at least one function part that is worn on a user's neck using a string,
wherein the string is provided with an earphone part and a retainer, and
the earphone part is worn on the user's ear by pulling the string while holding the retainer when the wearable device is worn on the user's neck.

19. The wearable device of claim 18, wherein an earphone is formed at an end of the string.
